(19) United States
(12) Patent Application Publication
(10) Pub. No.: US 2006/0209954 A1
(43) Pub. Date: Sep. 21, 2006

(54) Method and apparatus for providing a rate control for interlace coding

(76) Inventors: Limin Wang, San Diego, CA (US); Xue Fang, San Diego, CA (US); Jian Zhou, San Diego, CA (US)

Correspondence Address: PATTERSON & SHERIDAN L.L.P., 595 SHREWSBURY AVE, STE 100, FIRST FLOOR, SHREWSBURY, NJ, 07702, US

(21) Appl. No.: 11/083,255

(22) Filed: Mar. 16, 2005

(51) Int. Cl. H04N 7/12; H04N 11/04; H04B 1/66; H04N 11/02

(52) U.S. Cl. 375/240.12; 375/240.24

(57) ABSTRACT

The present invention discloses a system and method for providing a rate control to an encoder, e.g., a H.264/MPEG-4 AVC compliant encoder. For example, the rate control method computes a target group of pictures (GOP) rate for a GOP of the input image sequence. The rate control method then computes a target rate per picture from the target GOP rate. In one embodiment, the target rate comprises at least one of: a frame picture target rate and a field picture target rate, wherein the field picture target rate is computed in accordance with two complexity measures for two predicted (P) fields, one complexity measure for one intra (I) field and one complexity measure for one bi-predicted (B) field.

### BACKGROUND OF THE INVENTION

1. Field of the Invention

Embodiments of the present invention generally relate to an encoding system. More specifically, the present invention relates to a rate control method that is employed in a motion compensated encoder.

2. Description of the Related Art

Demands for lower bit-rates and higher video quality requires efficient use of bandwidth. To achieve these goals, the Moving Picture Experts Group (MPEG) created the ISO/IEC international Standards 11172 (1991) (generally referred to as MPEG-1 format) and 13818 (1995) (generally referred to as MPEG-2 format), which are incorporated herein in their entirety by reference. Although these encoding standards were very effective, new and improved encoding standards, e.g., H.264/MPEG-4 AVC, have been developed.

H.264/MPEG-4 AVC is a new video coding standard that achieves data compression by utilizing the coding tools, such as spatial and temporal prediction, transform and quantization, entropy coding, and etc. Unlike other existing video coding standards, H.264 supports frame coding, field coding and picture adaptive frame and field coding. Hence, the rate control methods designed based upon other existing video coding standards, for example, the MPEG-2 TM5 rate control, may not readily be applicable to H.264 encoder directly.

Thus, there is a need in the art for a rate control method that can be deployed in new encoding standards such as H.264/MPEG-4 AVC.

### SUMMARY OF THE INVENTION

In one embodiment, the present invention discloses a system and method for providing a rate control to an encoder, e.g., a H.264/MPEG-4 AVC compliant encoder. For example, the rate control method computes a target group of pictures (GOP) rate for a GOP of the input image sequence. The rate control method then computes a target rate per picture from the target GOP rate. In one embodiment, the target rate comprises at least one of: a frame picture target rate and a field picture target rate, wherein the field picture target rate is computed in accordance with two complexity measures for two predicted (P) fields, one complexity measure for one intra (I) field and one complexity measure for one bi-predicted (B) field.

In an alternative embodiment, a novel rate control method computes a buffer fullness and then adjusts the buffer fullness in accordance with a total activity measure or a total cost measure. The adjusted buffer fullness is then used to compute a quantization stepsize and/or a quantization parameter. Finally, each macroblock can be encoded in accordance with said quantization parameter (QP).

In one embodiment, the quantization parameter is optionally adaptively adjusted in accordance with spatial local activity.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a motion compensated encoder of the present invention;

FIG. 2 illustrates a method for performing rate control of the present invention; and

FIG. 3 illustrates the present invention implemented using a general purpose computer.

To facilitate understanding, identical reference numerals have been used, wherever possible, to designate identical elements that are common to the figures.

### DETAILED DESCRIPTION OF THE PREFERRED EMBODIMENT

It should be noted that although the present invention is described within the context of H.264/MPEG-4 AVC, the present invention is not so limited. Namely, the present motion compensated encoder can be an H.264/MPEG-4 AVC compliant encoder or an encoder that is compliant to any other compression standards that are capable of exploiting the present rate control scheme.

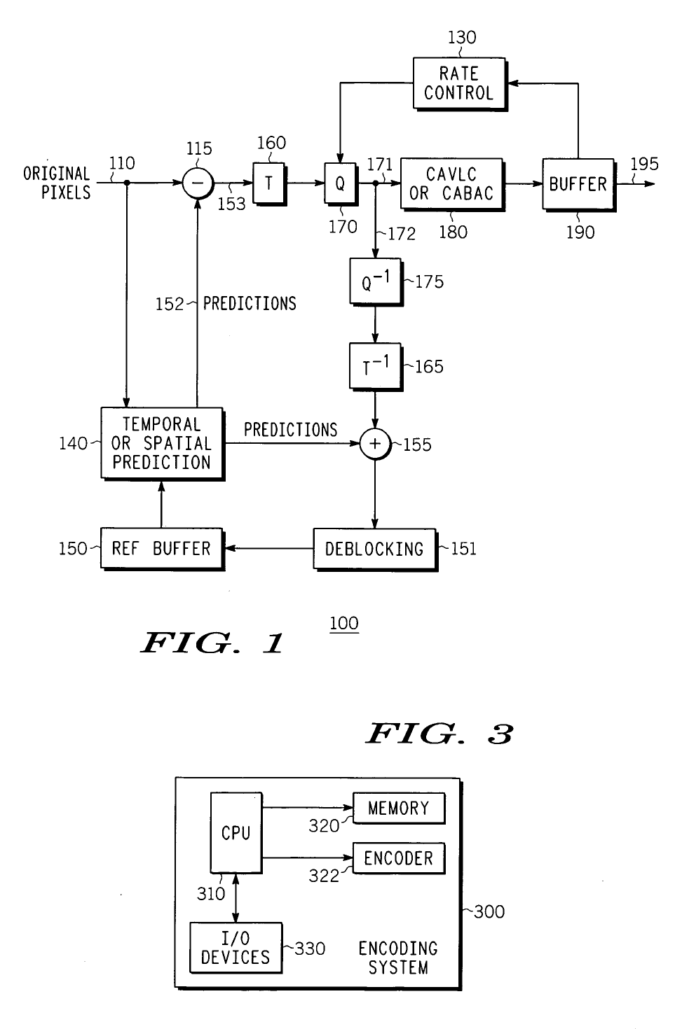

FIG. 1 depicts a block diagram of an exemplary motion compensated encoder 100 of the present invention. In one embodiment of the present invention, the apparatus 100 is an encoder or a portion of a more complex motion compensation coding system. The apparatus 100 comprises a temporal or spatial prediction module 140 (e.g., comprising a variable block motion estimation module and a motion compensation module), a rate control module 130, a transform module 160, e.g., a discrete cosine transform (DCT) based module, a quantization (Q) module 170, a context adaptive variable length coding (CAVLC) module or context-adaptive binary arithmetic coding module (CABAC)180, a buffer (BUF) 190, an inverse quantization (Q⁻¹) module 175, an inverse DCT (DCT⁻¹)transform module 165, a subtractor 115, a summer 155, a deblocking module 151, and a reference buffer 150. Although the apparatus 100 comprises a plurality of modules, those skilled in the art will realize that the functions performed by the various modules are not required to be isolated into separate modules as shown in FIG. 1. For example, the set of modules comprising the temporal or spatial prediction module 140, inverse quantization module 175 and inverse DCT module 165 is generally known as an “embedded decoder”.

FIG. 1 illustrates an input video image (image sequence) on path 110 which is digitized and represented as a luminance and two color difference signals (Y, Cᵣ, C_{b}) in accordance with the MPEG standards. These signals can be further divided into a plurality of layers (sequence, group of pictures, picture, slice and blocks) such that each picture (frame) is represented by a plurality of blocks having different sizes. The division of a picture into block units improves the ability to discern changes between two successive pictures and improves image compression through the elimination of low amplitude transformed coefficients. The digitized signal may optionally undergo preprocessing such as format conversion for selecting an appropriate window, resolution and input format.

The input video image on path 110 is received into temporal or spatial prediction module 140 for performing spatial prediction and for estimating motion vectors for temporal prediction. In one embodiment, the temporal or spatial prediction module 140 comprises a variable block motion estimation module and a motion compensation module. The motion vectors from the variable block motion estimation module are received by the motion compensation module for improving the efficiency of the prediction of sample values. Motion compensation involves a prediction that uses motion vectors to provide offsets into the past and/or future reference frames containing previously decoded sample values that are used to form the prediction error. Namely, the temporal or spatial prediction module 140 uses the previously decoded frame and the motion vectors to construct an estimate of the current frame.

The temporal or spatial prediction module 140 may also perform spatial prediction processing, e.g., directional spatial prediction (DSP). Directional spatial prediction can be implemented for intra coding, for extrapolating the edges of the previously-decoded parts of the current picture and applying it in regions of pictures that are intra coded. This improves the quality of the prediction signal, and also allows prediction from neighboring areas that were not coded using intra coding.

Furthermore, prior to performing motion compensation prediction for a given block, a coding mode must be selected. In the area of coding mode decision, MPEG provides a plurality of different coding modes. Generally, these coding modes are grouped into two broad classifications, inter mode coding and intra mode coding. Intra mode coding involves the coding of a block or picture that uses information only from that block or picture. Conversely, inter mode coding involves the coding of a block or picture that uses information both from itself and from blocks and pictures occurring at different times.

Once a coding mode is selected, temporal or spatial prediction module 140 generates a motion compensated prediction (predicted image) on path 152 of the contents of the block based on past and/or future reference pictures. This motion compensated prediction on path 152 is subtracted via subtractor 115 from the video image on path 110 in the current block to form an error signal or predictive residual signal on path 153. The formation of the predictive residual signal effectively removes redundant information in the input video image. Namely, instead of transmitting the actual video image via a transmission channel, only the information necessary to generate the predictions of the video image and the errors of these predictions are transmitted, thereby significantly reducing the amount of data needed to be transmitted. To further reduce the bit rate, predictive residual signal on path 153 is passed to the transform module 160 for encoding.

The transform module 160 then applies a DCT-based transform. Although the transform in H.264/MPEG-4 AVC is still DCT-based, there are some fundamental differences as compared to other existing video coding standards. First, transform is an integer transform, that is, all operations are carried out with integer arithmetic. Second, the inverse transform is fully specified. Hence, there is no mismatch between the encoder and the decoder. Third, transform is multiplication free, requiring only the addition and shift operations. Fourth, a scaling multiplication that is part of the complete transform is integrated into the quantizer, reducing the total number of multiplications.

Specifically, in H.264/MPEG-4 AVC the transformation is applied to 4×4 blocks, where a separable integer transform is applied. An additional 2×2 transform is applied to the four DC coefficients of each chroma component.

The resulting transformed coefficients are received by quantization module 170 where the transform coefficients are quantized. H.264/MPEG-4 AVC uses scalar quantization. One of 52 quantizers or quantization parameters (QP)s is selected for each macroblock.

The resulting quantized transformed coefficients are then decoded in inverse quantization module 175 and inverse DCT module 165 to recover the reference frame(s) or picture(s) that will be stored in reference buffer 150. In H.264/MPEG-4 AVC an in-loop deblocking filter 151 is also employed to minimize blockiness.

The resulting quantized transformed coefficients from the quantization module 170 are also received by context-adaptive variable length coding module (CAVLC) module or context-adaptive binary arithmetic coding module (CABAC)180 via signal connection 171, where the two-dimensional block of quantized coefficients is scanned using a particular scanning mode, e.g., a “zig-zag” order, to convert it into a one-dimensional string of quantized transformed coefficients. In CAVLC, VLC tables for various syntax elements are switched, depending on already-transmitted syntax elements. Since the VLC tables are designed to match the corresponding conditioned statistics, the entropy coding performance is improved in comparison to methods that just use one VLC table.

Alternatively, CABAC can be employed. CABAC achieves good compression by a) selecting probability models for each syntax element according to the element's context, b) adapting probability estimates based on local statistics and c) using arithmetic coding.

The data stream is received into a “First In-First Out” (FIFO) buffer 190. A consequence of using different picture types and variable length coding is that the overall bit rate into the FIFO is variable. Namely, the number of bits used to code each frame can be different. In applications that involve a fixed-rate channel, a FIFO buffer is used to match the encoder output to the channel for smoothing the bit rate. Thus, the output signal of FIFO buffer 190 is a compressed representation of the input video image 110, where it is sent to a storage medium or telecommunication channel on path 195.

The rate control module 130 serves to monitor and adjust the bit rate of the data stream entering the FIFO buffer 190 for preventing overflow and underflow on the decoder side (within a receiver or target storage device, not shown) after transmission of the data stream. A fixed-rate channel is assumed to put bits at a constant rate into an-input buffer within the decoder. At regular intervals determined by the picture rate, the decoder instantaneously removes all the bits for the next picture from its input buffer. If there are too few bits in the input buffer, i.e., all the bits for the next picture have not been received, then the input buffer underflows resulting in an error. On the other hand, if there are too many bits in the input buffer, i.e., the capacity of the input buffer is exceeded between picture starts, then the input buffer overflows resulting in an overflow error. Thus, it is the task of the rate control module 130 to monitor the status of buffer 190 to control the number of bits generated by the encoder, thereby preventing the overflow and underflow conditions. Rate control algorithms play an important role in affecting image quality and compression efficiency.

In one embodiment, the proper selection of the quantization parameter (QP) for a macroblock (MB) in the rate control module 130 is determined in accordance with the method of the present invention. Existing video coding standards allow adjusting the quantization stepsize Qₛₜₑₚ locally, in particular, at the MB level. Rate control can therefore be achieved by controlling the quantization stepsize Qₛₜₑₚ per MB. The rate control algorithms based upon other video coding standards, such as the most commonly used MPEG2 TM5 rate control or like, cannot be directly applied to the H.264/MPEG-4 AVC encoder. This is because H.264 blends the transform and quantization operations together, and it only allows the change in QP per MB. QP is a quantization parameter, not the quantization stepsize Qₛₜₑₚ. Rate control for the H.264/MPEG-4 AVC encoder can only be achieved by properly selecting value of QP. As discussed above, there are a total of 52 possible values in QP.

It should be noted that the present invention is described from the perspective of pictures in the input image sequence. However, the present invention is not so limited. Namely, the present invention can be perceived from the perspective of slices in the input image sequence, where the size of the slices is one picture.

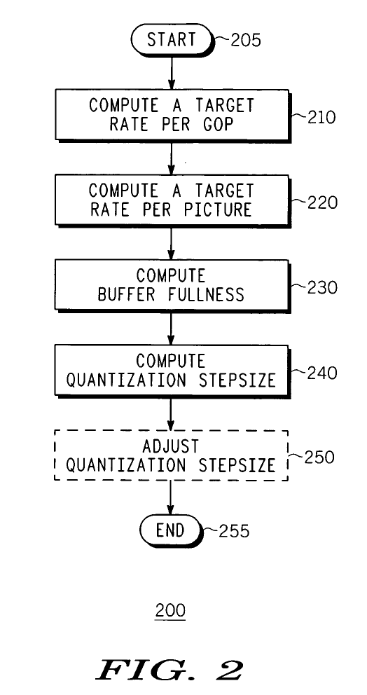

FIG. 2 illustrates a method 200 for performing rate control of the present invention. In one embodiment, the rate control method can be broadly perceived as comprising three broad steps. The steps are: 1) bit allocation, 2) computation of quantization step size and/or quantization parameter, and 3) adaptive quantization. For example, bit allocation assigns a target number of bits per picture. In turn, rate control adjusts the QP per MB to achieve that target number of bits per picture. Optionally, adaptive quantization can be further employed to modulate the QP determined in step 2 using a local activity measure.

Method 200 starts in step 205 and proceeds to step 210. In step 210, method 200 computes a target rate per group of pictures (GOP). For example, pictures of an input video sequence can be grouped into GOPs. A GOP may contain one intra (I) picture and a few predicted (P) pictures. There may be one or more bi-predicted (B) pictures between the I and/or P pictures. As is known in the art, Intra pictures are encoded without referring to reference pictures, whereas P and B pictures are coded by referring to one or more reference pictures. A group of successive B pictures plus the following I or P picture may be called a sub_GOP. A GOP can be described by the numbers of pictures per GOP and per sub_GOP, that is, the GOP length, N_{GOP}, and the sub_GOP length, N_{sub}_{_{—}}_{GOP}.

In one embodiment, given a target bit rate of bit_rate in bits per second and a picture rate of pic_rate in pictures per second, a GOP of N_{GOP} pictures is budgeted a nominal number of bits as:
R_{GOP}_{_{—}}ₙₒₘᵢₙₐₗ=N_{GOP}×bit_rate/pic_rate. (1)

In one embodiment, at the beginning of a GOP, a target number of bits, R_{GOP}_{_{—}}_{remaining}, is set as:
R_{GOP}_{_{—}}_{remaining}=R_{GOP}_{_{—}}_{remaining}+R_{GOP}_{_{—}}ₙₒₘᵢₙₐₗ (2)
where R_{GOP}_{_{—}}_{remaining} on the right is the number of bits left over from the previous GOP. It should be noted that R_{GOP}_{_{—}}_{remaining} on the right of the equation can also be a negative value if the previous GOP exceeded its bit allocation. For the first GOP of a sequence, R_{GOP}_{_{—}}_{remaining} on the right is set to 0 bits.

Returning to FIG. 2, once a target GOP rate has been computed, method 200 proceeds to step 220. In step 220, method 200 computes a target rate per picture.

To illustrate, given a target number of bits for a GOP, a picture of pic_type I, P or B is assigned a target number of bits, R_{target}, according to its relative complex measure, C_{pic}_{_{—}}_{type}, over other pictures within the current GOP. It should be noted that an interlace picture of two fields can be encoded as a single frame picture or as two separate field pictures. H.264 allows adaptive switching between frame and field picture coding. The present rate control method therefore maintains two sets of the complexity measures of pic_type I, P and B pictures. One is for frame pictures and the other is for field pictures.

For a frame picture, the target number of bits is set as:

$${R}_{target} = \frac{{K}_{pic\_type} {C}_{pic\_type} {R}_{GOP\_remaining}}{\begin{matrix}{K}_{ I} {n}_{ frame\_ 1} {C}_{ frame\_ 1} + {K}_{ P} {n}_{ frame\_P} {C}_{ frame\_p} + \\ {K}_{ B} {n}_{ frame\_B} {C}_{ frame\_B}\end{matrix}} , \qquad ( 3 )$$

and for a field picture, the target number of bits is set as:

$${R}_{target} = \frac{{K}_{pic\_type} {C}_{pic\_type} {R}_{GOP\_remaining}}{\begin{matrix}{K}_{ I} {n}_{ field\_I} {C}_{ fieldI} + {K}_{ P} ( {n}_{ field0\_P} {C}_{ field0\_P} + \\ {n}_{ field1\_P} {C}_{ field1\_P} ) + {K}_{B} {n}_{field\_B} {C}_{field\_B}\end{matrix}} , \qquad ( 4 )$$

where
pic_type indicates the picture type of I, P or B for the current picture;
C_{frame}_{_{—}}_{I}, C_{frame}_{_{—}}_{P} and C_{frame}_{_{—}}_{B} are the complex measures for frame pictures of pic_type I, P and B, respectively. C_{field}_{_{—}}_{I}, C_{field0}_{_{—}}_{P}, C_{field1}_{_{—}}_{P} and C_{field}_{_{—}}_{B} are the complex measures for I field, P field 0, P field 1 and B field pictures, respectively (where fiel 0 and fiel 1 can be a top field and a bottom field or vice versa);
K_{I}, K_{P}, and K_{B}, are the pre-set constants for pictures of pic_type I, P and B, respectively. In one embodiment, K_{I}=K_{P}=1 and K_{B}=1/1.4; and
n_{frame}_{_{—}}_{I}, n_{frame}_{_{—}}_{P} and n_{frame}_{_{—}}_{B} are the remaining numbers of I, P and B frame pictures in the current GOP. n_{field}_{_{—}}_{I}, n_{field0}_{_{—}}_{P}, n_{field1}_{_{—}}_{P} and n_{field}_{_{—}}_{B} are the remaining numbers of I field, P field 0, P fiel 1 and B field pictures in the current GOP.

Thus, equations 3 and 4 above are used to compute a target bit rate for a current frame picture or a current field picture, respectively as each frame or field is encoded. In other words, as each picture of the GOP is encoded, the encoder is able to update the picture target rate using the number of bits that the encoder just spent in encoding a previous picture (either framed encoded or field encoded).

It should be noted that the field picture target rate as computed using equation (4) is computed in accordance with two complexity measures for two predicted (P) fields, only one complexity measure for one intra (I) field and only one complexity measure for one bi-predicted (B) field. Namely, there is no need to compute two complexity measures for the I picture and the B picture. This approach saves computational cycles because generating only the complexity measure for either fields of the I picture and B picture will be adequate to properly compute the target rate for the picture.

In one embodiment, after encoding a picture of I, P or B, the remaining number of bits for the current GOP is updated as,
R_{GOP}_{_{—}}_{remaining}=R_{GOP}_{_{—}}_{remaining}−R_{actual}, (5)
where R_{actual} is the actual number of bits used for the picture.

In one embodiment, the complexity measure of pic_type I, P or B is defined as the product of the number of bits used and the associated coding distortion for a picture of pic_type I, P or B, that is:
C_{pic}_{_{—}}_{type}=R_{actual}×D (6)
where D is the coding distortion. For example, D can be the mean square error (MSE), but other distortion measure can be employed as well. The complexity measure of pic_type I, P or B is updated after a frame or field picture of I, P or B is encoded. In other words, the actual number of bits spent in encoding the pertinent picture type (e.g., a top field of a P picture) can be used to update the complexity measure of that picture type (e.g., a C of a top field of a P picture).

In one exemplary embodiment, the numbers of I, P and B (frame) pictures per GOP, N_{I}, N_{P} and N_{B}, are set as:

$$\{ \begin{matrix} {N}_{I} = 1 , \\ {N}_{P} = ( {N}_{GOP} / {N}_{sub\_GOP} ) - 1 , \\ {N}_{B} = {N}_{GOP} - {N}_{I} - {N}_{P} .\end{matrix} \qquad ( 7 )$$

At the beginning of a GOP, the remaining numbers of I, P and B frame and field pictures for the current GOP are set as:

$$\{ \begin{matrix}{n}_{frame\_I} = {N}_{I} , \\ {n}_{frame\_P} = {N}_{P} , \\ {n}_{frame\_B} = {N}_{B} .\end{matrix} \qquad ( 8 )$$

and if I picture is configured to be coded as two I fields in field mode,

$$\{ \begin{matrix} {n}_{field\_I} = 2 ; \\ {n}_{field0\_P} = {N}_{P} ; \\ {n}_{field1\_P} = {N}_{P} ; \\ {n}_{field\_B} = 2 \times {N}_{B}\end{matrix} \qquad ( 9 a )$$

or if I picture is configured to be coded as one I field followed by one P field in field mode,

$$\{ \begin{matrix} {n}_{field\_I} = 1 , \\ {n}_{field0\_P} = {N}_{P} , \\ {n}_{field1\_P} = {N}_{P} + 1 \\ {n}_{field\_B} = 2 \times {N}_{B} .\end{matrix} \qquad ( 9 b )$$

of if I picture is configured to be coded as one P field followed by one I field in field mode

$$\{ \begin{matrix} {n}_{field\_I} = 1 ; \\ {n}_{field0\_P} = {N}_{P} + 1 ; \\ {n}_{field1\_P} = {N}_{P} ; \\ {n}_{field\_B} = 2 \times {N}_{B} ;\end{matrix} \qquad ( 9 c )$$

After a frame picture of I, P or B is encoded, the corresponding number of I, P or B pictures in the current GOP is updated as:

if (I picture is encoded)

and if I picture is configured to be coded as two I fields in field mode,
n_{frame}_{_{—}}_{I}−−;
n_{field}_{_{—}}_{I}−=2; (10a)
or if I picture is configured to be coded as one I field followed by one P field in field mode,
n_{frame}_{_{—}}_{I}−−;
n_{field}_{_{—}}_{I}−−;
n_{fieldI}_{_{—}}_{P}−−; (10b)
of if I picture is configured to be coded as one P field followed by one I field in field mode,
n_{frame}_{_{—}}_{I}−−;
n_{field}_{_{—}}_{I}−−;
n_{field0}_{_{—}}_{P}−−; (10c)
else if (P picture is encoded)
n_{frame}_{_{—}}_{P}−−;
n_{field0}_{_{—}}_{P}−−;
n_{field1}_{_{—}}_{P}−−; (11)
else
n_{frame}_{_{—}}_{B}−−;
n_{field}_{_{—}}_{B}−=2; (12)
where “−−” indicates −1 and where “−=2” indicates −2.

It should be noted that in one embodiment (as shown in equation 10), when an I picture is encoded as a frame, the count for the I field is decremented by two, or by one and also the count for P field (either the top field count or the bottom file count) is decremented by one, depending upon if the I picture is coded as two I fields or as one I field and one P field. The reason for coding an I picture as one I field and one P field is that it is possible to encode the P field by referring to the (top or bottom) encoded I field as a reference.

After field 0 of I, P, or B is encoded, the corresponding number of I, P or B pictures in the current GOP is updated as:

if (I picture is encoded)
n_{field}_{_{—}}_{I}−−; (13)
else if (P picture is encoded)
n_{field0}_{_{—}}_{P}−−; (14)
else
n_{field}_{_{—}}_{B}−−; (15)

After field 1 of I, P, or B is encoded, the corresponding number of I, P or B pictures in the current GOP is updated as:

If (I picture)
n_{frame}_{_{—}}_{I}−−;
n_{field}_{_{—}}_{I}−−; (16)
else if (P picture)
if field 0 is I picture, n_{frame}_{_{—}}_{I}−−;
if field 0 is P picture, n_{frame}_{_{—}}_{P}−−;
n_{field1}_{_{—}}_{P}−−; (17)
else
n_{frame}_{_{—}}_{B}−−;
n_{field}_{_{—}}_{B}−−;. (18)

It should be noted above that field 0 of a picture can be coded as an I field or a P field when field 1 is coded as a P field. As such, equation (17) indicates how various parameters are decremented depending on how the first field of a picture is encoded.

In one exemplary embodiment, at the beginning of a sequence, the initial complex measures for frame and field pictures are set as:

$$\begin{matrix}\{ \begin{matrix} {C}_{frame\_I} = 160 , \\ {C}_{frame\_P} = 60 , \\ {C}_{frame\_B} = 42.\end{matrix} \\ and & ( 19 ) \\ \{ \begin{matrix} {C}_{field\_I} = 160 , \\ {C}_{ field0\_P} = 60 , \\ {C}_{ field1\_P} = 42 , \\ {C}_{field\_B} = 42.\end{matrix} & ( 20 )\end{matrix}$$

In addition, after the first I and P frame pictures, the complexity measure for B frame picture is set as:
C_{frame}_{_{—}}_{B}=(42/60)×C_{frane}_{_{—}}_{P}. (21)

If the first I frame is coded as one I field and one P field, the complexity measures for P field 0 and B field pictures are set as:

$$\{ \begin{matrix} {C}_{field0\_P} = ( 60 / 42 ) \times {C}_{field1\_p} , \\ {C}_{field\_B} = {C}_{field1\_P} .\end{matrix} \qquad ( 22 )$$

Note that the above settings for complexity measures are implemented only once per sequence.

Returning to FIG. 2, once a target rate per picture has been computed, method 200 will compute a buffer fullness in step 230. It should be noted that H.264/MPEG-4 AVC allows a total of 52 possible values in QP. These values are 0, 1, 2, . . . , 51. The target number of bits per (frame or field) picture can be achieved by properly selecting value of QP per MB.

In one embodiment, given a target number of bits for the current picture, R_{target}, the rate control method will first determine a reference (not final) quantization parameter, QP, at MB (j) based upon a virtual buffer fullness. The fullness of a virtual buffer of pic_type I, P or B at MB (j) is computed as:

$${d}_{j}^{pic\_type} = {d}_{0}^{pic\_type} + {R}_{j - 1} - ( j - 1 ) \times \frac{{R}_{target}}{M {B}_{pic}} \qquad ( 23 )$$

where
d₀^{pic}^{_{—}}^{type} is the initial fullness of the virtual buffer at the beginning of the current picture of pic_type I, P or B. The final fullness of virtual buffer of the current picture, dⱼ^{pic}^{_{—}}^{type}, j=MB_{pic} is used as d₀^{pic}^{_{—}}^{type} for the next picture of the same pic_type;
Rⱼ₋₁ is the number of bits generated for encoding all the MBs in the current picture up to and including MB (j−1); and
MB_{pic} is the total number of MBs in the current picture.
   The above assumes that each MB uses the same nominal number of bits.

In one embodiment, an alternate method weighs the bit budget per MB according to its need. For example,

$${d}_{j}^{pic\_type} = {d}_{0}^{pic\_type} + {R}_{j - 1} - {\sum }_{i = 0}^{j - 1} \frac{{act}_{i}}{total\_act} {R}_{target} \qquad ( 24 )$$

where actᵢ is the local activity measure of MB (i) (which is defined below),

$$total\_act = {\sum }_{i} {act}_{i}$$

and the index i is over all the MBs in the current picture. Or

$${d}_{j}^{pic\_type} = {d}_{0}^{pic\_type} + {R}_{j - 1} - {\sum }_{i = 0}^{j - 1} \frac{{cost}_{i}}{total\_cost} {R}_{target} \qquad ( 25 )$$

where costᵢ is the cost measure of MB (i) (often used in mode decision), and

$$total\_cos t = {\sum }_{i} {cost}_{i}$$

and the index i is over all the MBs in the current picture.
This option tends to distribute the bits over MBs of a picture according to their need.

In one embodiment, the initial values of the virtual buffer fullness are set as:
d₀¹=d₀^{p}=d₀^{B}=bit_rate/pic_rate. (26)
Note that frame and field pictures maintain separate sets of virtual buffer fullness.

Returning to FIG. 2, once the buffer fullness has been computed, the method 200 computes a quantization stepsize in step 240. In one embodiment, the quantization stepsize for the current MBO) is set proportional to the fullness of virtual buffer as:
Qⱼ=51×(pic_rate/bit_rate)×dⱼ (27)

The quantization stepsize, Qⱼ, can then be converted into the reference quantization parameter by:
QP=[6×log₂(Qⱼ)+c] (28)
where constant c is set to a value of 4 in one embodiment.

Returning to FIG. 2, once the quantization stepsize and/or quantization parameter has been computed for a macroblock, the macroblock can be encoded accordingly. However, method 200 may optionally adjust the quantization stepsize, e.g., employing adaptive quantization in optional step 250.

For example, in one embodiment, the reference quantization parameter for a MB, QP, is further modulated by the spatial local activity of the MB. For picture AFF coding, a MB can be in frame picture or field picture.

The spatial local activity measure of MBj), actⱼ, is computed using the original pixel values of the MB, that is:
actⱼ=1+min(var_blockₖ|k=1,2, . . . , 2×(16/n)×(16/m)) (29)
where var_blockₖ is the variance of MB/sub_MB partition (k), defined as:

$$\begin{matrix}{var\_block}_{k} = \frac{1}{n \times m} {\sum }_{i , j = 0}^{n , m} {( {x}_{k} ( i , j ) - {mean\_block}_{k} )}^{2} , & ( 30 ) \\ {mean\_block}_{k} = \frac{1}{n \times m} {\sum }_{i , j = 0}^{n , m} {x}_{k} ( i , j ) & ( 31 )\end{matrix}$$

and xₖ (i,j) are the original pixel values of MB/sub_MB partition (k). Normalized local activity is given by:

$${N\_act}_{j} = \frac{β \times {act}_{j} + avg\_act}{{act}_{j} + β \times avg\_act} \qquad ( 32 )$$

where β is a constant and avg_act is the average value of actⱼ of the picture.

The reference quantization parameter QP determined above is then modulated by N_actⱼ, giving the final QP for the current MB (j), that is:
QP=QP+6×log₂(N_actⱼ). (33)

In one embodiment, the range of modulation is controlled by β. In one embodiment, β is set to a value of 2. The final QP may need to be further clipped into the allowable range of [0, 51].

Returning to FIG. 2, the method 200 then ends in step 255.

In one embodiment, additional buffer protection can be employed. For example, the encoder buffer size of buffer_size is set to one second. Assume that the decoder buffer is of the same size (buffer_size) as the encoder buffer. To prevent the buffer overflow and underflow, the target number of bits determined for the current picture in bit allocation, R_{target}, may need to be checked.

It is assumed that the bits generated per picture are moved into the encoder buffer during an interval of 0 second, and the bits are moved out the encoder buffer at a constant rate of bit_rate/pic_rete. Let buffer_occupancy be the buffer occupancy of the encoder buffer. Before encoding a picture, the method may check and if necessary, may adjust the target number of bits assigned for the picture as:
If buffer_occupancy+R_{target}>0.9×buffer_size,
then R_{target}=0.9×buffer_size−buffer_occupancy,
and
If buffer_occupancy+R_{target}−bit_rate/pic_rate<0.1×buffer_size,
then R_{target}=0.1×buffer_size−buffer_occupancy+bit_rate/pic_rate.

FIG. 3 is a block diagram of the present encoding system being implemented with a general purpose computer. In one embodiment, the encoding system 300 is implemented using a general purpose computer or any other hardware equivalents. More specifically, the encoding system 300 comprises a processor (CPU) 310, a memory 320, e.g., random access memory (RAM) and/or read only memory (ROM), an encoder 322 employing the present method of rate control, and various input/output devices 330 (e.g., storage devices, including but not limited to, a tape drive, a floppy drive, a hard disk drive or a compact disk drive, a receiver, a transmitter, a speaker, a display, an output port, a user input device (such as a keyboard, a keypad, a mouse, and the like), or a microphone for capturing speech commands).

It should be understood that the encoder 322 can be implemented as physical devices or subsystems that are coupled to the CPU 310 through a communication channel. Alternatively, the encoder 322 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 320 of the computer. As such, the encoder 322 (including associated data structures and methods employed within the encoder) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for providing a rate control in an encoder for encoding an image sequence, comprising:
computing a target rate for a group of pictures (GOP) of the image sequence, wherein said GOP comprises a plurality of pictures; and
computing a target rate for each of said pictures from said target rate for said GOP, wherein said target rate comprises at least one of: a frame picture target rate and a field picture target rate, wherein said field picture target rate is computed in accordance with two complexity measures for two predicted (P) fields, one complexity measure for one intra (I) field and one complexity measure for one bi-predicted (B) field.

2. The method of claim 1, wherein said for two predicted (P) fields comprise a top P field and a bottom P field.

3. The method of claim 1, wherein said target rate, R_{target}, for each of said pictures is computed in accordance with:
$${R}_{target} = \frac{{K}_{pic\_type} {C}_{pic\_type} {R}_{GOP\_remaining}}{\begin{matrix}{K}_{I} {n}_{field\_I} {C}_{fieldI} + {K}_{P} ( {n}_{field 0 \_P} {C}_{field 0 \_P} + {n}_{field 1 \_P} {C}_{field 1 \_P} ) + \\ {K}_{B} {n}_{field\_B} {C}_{field\_B}\end{matrix}} ,$$
where pic_type indicates a picture type of I, P or B for a current picture, where C_{field}_{_{—}}_{I} is a complexity measure for said I field, where C_{field0}_{_{—}}_{P} is a complexity measure for one of said two P fields, where C_{field1}_{_{—}}_{P} is a complexity measure for another one of said two P fields, where C_{field}_{_{—}}_{B} is a complexity measure for said B field, where K_{I}, K_{P}, and K_{B}, are constants for pictures of pic_type I, P and B, respectively, where n_{field}_{_{—}}_{I}, n_{field0}_{_{—}}_{P}, n_{field1}_{_{—}}_{P} and n_{field}_{_{—}}_{B} are remaining numbers of I field, P field 0, P field 1 and B field in said GOP, and where R_{GOP}_{_{—}}_{remaining} is a remaining number of bits for said GOP.

4. The method of claim 3, further comprising:
encoding one of said pictures from said GOP; and
updating at least one of said n_{field}_{_{—}}_{I}, n_{field0}_{_{—}}_{P}, n_{field1}_{_{—}}_{P}, and n_{field}_{_{—}}_{B}, where one of said n_{field0}_{_{—}}_{P}, and n_{field1}_{_{—}}_{P} is updated if said encoded picture is encoded as a frame I picture, or where only one of said n_{field0}_{_{—}}_{P}, and n_{field1}_{_{—}}_{P} is updated if said encoded picture is encoded as a field P picture.

5. The method of claim 1, further comprising:
computing a buffer fullness; and
adjusting said buffer fullness in accordance with a total activity measure or a total cost measure.

6. The method of claim 5, wherein said buffer fullness is adjusted in accordance with:
$${d}_{j}^{pic\_type} = {d}_{0}^{pic\_type} + {R}_{j - 1} - {\sum }_{i = 0}^{j - 1} \frac{{act}_{i}}{total\_act} {R}_{target} ,$$
where d₀^{pic}^{_{—}}^{type} is an initial fullness of a virtual buffer at a beginning of a current picture of pic_type I, P or B, where dⱼ^{pic}^{_{—}}^{type} is a current fullness of said virtual buffer of a current picture, where Rⱼ₋₁ is a number of bits generated for encoding all macroblocks (MBs) in the current picture up to and including MB (j−1), where actᵢ is a local activity measure of one MB (i), where
$$total\_act = {\sum }_{i} {act}_{i}$$
and where
R_{target} is a target rate for the current picture.

7. The method of claim 5, wherein said buffer fullness is adjusted in accordance with:
$${d}_{j}^{pic\_type} = {d}_{0}^{pic\_type} + {R}_{j - 1} - {\sum }_{i = 0}^{j - 1} \frac{{cost}_{i}}{total\_cost} {R}_{target}$$
where d₀^{pic}^{_{—}}^{type} is an initial fullness of a virtual buffer at a beginning of a current picture of pic_type I, P or B, where dⱼ^{pic}^{_{—}}^{type} is a current fullness of said virtual buffer of a current picture, where Rⱼ₋₁ is a number of bits generated for encoding all macroblocks (MBs) in the current picture up to and including MB (j−1), where costᵢ is the cost measure of MB (i), and
$$total\_cost = {\sum }_{i} {cost}_{i} ,$$
and where R_{target} is a target rate for the current picture.

8. A computer-readable carrier having stored thereon a plurality of instructions, the plurality of instructions including instructions which, when executed by a processor, cause the processor to perform the steps of a method for providing a rate control in an encoder for encoding an image sequence, comprising of:
computing a target rate for a group of pictures (GOP) of the image sequence, wherein said GOP comprises a plurality of pictures; and
computing a target rate for each of said pictures from said target rate for said GOP, wherein said target rate comprises at least one of: a frame picture target rate and a field picture target rate, wherein said field picture target rate is computed in accordance with two complexity measures for two predicted (P) fields, one complexity measure for one intra (I) field and one complexity measure for one bi-predicted (B) field.

9. The computer-readable carrier of claim 8, wherein said for two predicted (P) fields comprise a top P field and a bottom P field.

10. The computer-readable carrier of claim 8, wherein said target rate, R_{target}, for each of said pictures is computed in accordance with:
$${R}_{target} = \frac{{K}_{pic\_type} {C}_{pic\_type} {R}_{GOP\_remaining}}{\begin{matrix}{K}_{I} {n}_{field\_I} {C}_{field1} + {K}_{P} \\ ( {n}_{field0\_P} {C}_{field0\_P} + {n}_{field1\_P} {C}_{field1\_P} ) + {K}_{B} {n}_{field\_B} {C}_{field\_B}\end{matrix}} ,$$
where pic_type indicates a picture type of I, P or B for a current picture, where C_{field}_{_{—}}_{I} is a complexity measure for said I field, where C_{field0}_{_{—}}_{P} is a complexity measure for one of said two P fields, where C_{field1}_{_{—}}_{P} is a complexity measure for another one of said two P fields, where C_{field}_{_{—}}_{B} is a complexity measure for said B field, where K_{I}, K_{P}, and K_{B}, are constants for pictures of pic_type I, P and B, respectively, where n_{field}_{_{—}}_{I}, n_{field0}_{_{—}}_{P}, n_{field1}_{_{—}}_{P} and n_{field}_{_{—}}_{B} are remaining numbers of I field, P field 0, P field 1 and B field in said GOP, and where R_{GOP}_{_{—}}_{remaining} is a remaining number of bits for said GOP.

11. The computer-readable carrier of claim 10, further comprising:
encoding one of said pictures from said GOP; and
updating at least one of said n_{field}_{_{—}}_{I}, n_{field0}_{_{—}}_{P}, n_{field1}_{_{—}}_{P} and n_{field}_{_{—}}_{B}, where one of said n_{field0}_{_{—}}_{P}, and n_{field1}_{_{—}}_{P} is updated if said encoded picture is encoded as a frame I picture, or where only one of said n_{field0}_{_{—}}_{P}, and n_{field1}_{_{—}}_{P} is updated if said encoded picture is encoded as a field P picture.

12. The computer-readable carrier of claim 8, further comprising:
computing a buffer fullness; and
adjusting said buffer fullness in accordance with a total activity measure or a total cost measure.

13. The computer-readable carrier of claim 12, wherein said buffer fullness is adjusted in accordance with:
$${d}_{j}^{pic\_type} = {d}_{0}^{pic\_type} + {R}_{j - 1} - {\sum }_{i = 0}^{j - 1} \frac{{act}_{i}}{total\_act} {R}_{target} ,$$
where d₀^{pie}^{_{—}}^{type} is an initial fullness of a virtual buffer at a beginning of a current picture of pic_type I, P or B, where dⱼ^{pic}^{_{—}}^{type} is a current fullness of said virtual buffer of a current picture, where Rⱼ₋₁ is a number of bits generated for encoding all macroblocks (MBs) in the current picture up to and including MB (j−1), where acti is a local activity measure of one MB (i), where
$$total\_act = {\sum }_{i} {act}_{i}$$
and where R_{target} is a target rate for the current picture.

14. The computer-readable carrier of claim 12, wherein said buffer fullness is adjusted in accordance with:
$${d}_{j}^{pic\_type} = {d}_{0}^{pic\_type} + {R}_{j - 1} - {\sum }_{i = 0}^{j - 1} \frac{{cost}_{i}}{total\_cost} {R}_{target}$$
where d₀^{pic}^{_{—}}^{type} is an initial fullness of a virtual buffer at a beginning of a current picture of pic_type I, P or B, where dⱼ^{pic}^{_{—}}^{type} is a current fullness of said virtual buffer of a current picture, where Rⱼ₋₁ is a number of bits generated for encoding all macroblocks (MBs) in the current picture up to and including MB (j−1), where costᵢ is the cost measure of MB (i), and
$$total\_cost = {\sum }_{i} {cost}_{i} ,$$
and where R_{target} is a target rate for the current picture.

15. An apparatus for providing a rate control for encoding an image sequence, comprising:
means for computing a target rate for a group of pictures (GOP) of the image sequence, wherein said GOP comprises a plurality of pictures; and
means for computing a target rate for each of said pictures from said target rate for said GOP, wherein said target rate comprises at least one of: a frame picture target rate and a field picture target rate, wherein said field picture target rate is computed in accordance with two complexity measures for two predicted (P) fields, one complexity measure for one intra (I) field and one complexity measure for one bi-predicted (B) field.

16. The apparatus of claim 15, wherein said target rate, R_{target}, for each of said pictures is computed in accordance with:
$${R}_{target} = \frac{{K}_{pic\_type} {C}_{pic\_type} {R}_{GOP\_remaining}}{\begin{matrix}{K}_{I} {n}_{field\_I} {C}_{field1} + {K}_{P} \\ ( {n}_{field0\_P} {C}_{field0\_P} + {n}_{field1\_P} {C}_{field1\_P} ) + {K}_{B} {n}_{field\_B} {C}_{field\_B}\end{matrix}} ,$$
where pic_type indicates a picture type of I, P or B for a current picture, where C_{field}_{_{—}}_{I} is a complexity measure for said I field, where C_{field0}_{_{—}}_{P} is a complexity measure for one of said two P fields, where C_{field1}_{_{—}}_{B} is a complexity measure for another one of said two P fields, where C_{field}_{_{—}}_{B} is a complexity measure for said B field, where K_{I}, K_{P}, and K_{B}, are constants for pictures of pic_type I, P and B, respectively, where n_{field}_{_{—}}_{I}, n_{field0}_{_{—}}_{P}, n_{field1}_{_{—}}_{P} and n_{field}_{_{—}}_{B} are remaining numbers of I field, P field 0, P field 1 and B field in said GOP, and where R_{GOP}_{_{—}}_{remaining} is a remaining number of bits for said GOP.

17. The apparatus of claim 16, further comprising:
means for encoding one of said pictures from said GOP; and
means for updating at least one of said n_{field}_{_{—}}_{I}, n_{field0}_{_{—}}_{P}, n_{field1}_{_{—}}_{P} and n_{field}_{_{—}}_{B}, where one of said n_{field0}_{_{—}}_{P}, and n_{field1}_{_{—}}_{P} is updated if said encoded picture is encoded as a frame I picture, or where only one of said n_{field0}_{_{—}}_{P}, and n_{field1}_{_{—}}_{P} is updated if said encoded picture is encoded as a field P picture.

18. The apparatus of claim 15, further comprising:
means for computing a buffer fullness; and
means for adjusting said buffer fullness in accordance with a total activity measure or a total cost measure.

19. The apparatus of claim 18, wherein said buffer fullness is adjusted in accordance with:
$${d}_{j}^{pic\_type} = {d}_{0}^{pic\_type} + {R}_{j - 1} - {\sum }_{i = 0}^{j - 1} \frac{{act}_{i}}{total\_act} {R}_{target} ,$$
where d₀^{pic}^{_{—}}^{type} is an initial fullness of a virtual buffer at a beginning of a current picture of pic_type I, P or B, where dⱼ^{pic}^{_{—}}^{type} is a current fullness of said virtual buffer of a current picture, where Rⱼ₋₁ is a number of bits generated for encoding all macroblocks (MBs) in the current picture up to and including MB (j−1), where actᵢ is a local activity measure of one MB (i), where
$$total\_act = {\sum }_{i} {act}_{i}$$
and where R_{target} is a target rate for the current picture.

20. The apparatus of claim 18, wherein said buffer fullness is adjusted in accordance with:
$${d}_{j}^{pic\_type} = {d}_{0}^{pic\_type} + {R}_{j - 1} - {\sum }_{i = 0}^{j - 1} \frac{{cost}_{i}}{total\_cost} {R}_{target}$$
where d₀^{pic}^{_{—}}^{type} is an initial fullness of a virtual buffer at a beginning of a current picture of pic_type I, P or B, where dⱼ^{pic}^{_{—}}^{type} is a current fullness of said virtual buffer of a current picture, where Rⱼ₋₁ is a number of bits generated for encoding all macroblocks (MBs) in the current picture up to and including MB (j−1), where costᵢ is the cost measure of MB (i), and
$$total\_cos t = {\sum }_{i} cos {t}_{i} ,$$
and where R_{target} is a target rate for the current picture.
